(19) United States
(12) Patent Application Publication
(10) Pub. No.: US 2025/0280196 A1
(43) Pub. Date: Sep. 4, 2025

(54) IMAGE PICKUP APPARATUS THAT CONTROLS DISPLAY OF RETURN VIDEO, CONTROL METHOD THEREFOR, AND STORAGE MEDIUM

(71) Applicant: CANON KABUSHIKI KAISHA, Tokyo (JP)

(72) Inventor: TAKAYASU ANDO, Kanagawa (JP)

(21) Appl. No.: 19/049,305

(22) Filed: Feb. 10, 2025

(30) Foreign Application Priority Data
Mar. 1, 2024 (JP) 2024-031326

(51) Int. Cl. H04N 23/667; H04N 5/265; H04N 23/63

(52) U.S. Cl. CPC H04N 23/667; H04N 5/265; H04N 23/632

(57) ABSTRACT

An image pickup apparatus that can switch a method for displaying a return video in accordance with the need to display the return video, thereby reducing the inhibition caused by displaying a return video when displaying a self-shot video. The image pickup apparatus connected to an external apparatus receives a tally signal and a return video, and switches a method for displaying the return video. The method for displaying the return video is switched depending on a state of the tally signal.

### BACKGROUND OF THE INVENTION

### Field of the Invention

The present invention relates to an image pickup apparatus, a control method therefor, and a storage medium, and more particularly, to an image pickup apparatus that controls the display of a return video, a control method therefor, and a storage medium.

### Description of the Related Art

Conventionally, there exist a plurality of image pickup apparatuses constituting a photographic system, some are configured to display not only a self-shot video being shot by themselves but also a currently broadcasted/distributed video that has been received from a switcher as a return video.

To display such a return video, more specifically, to switch between the displays of a self-shot video and a return video, various techniques are utilized. For example, Japanese Laid-Open Patent Publication (kokai) No. 2011-223541 proposes a technique in which a user operates an external remote control to manually switch between the displayed and non-displayed states of a return video on a display unit of an image pickup apparatus.

In the technique proposed in Japanese Laid-Open Patent Publication (kokai) No. 2011-223541, however, the return video is displayed on the display unit of the image pickup apparatus in response to the user's operation on the remote control, regardless of whether the need to display the return video is great or small. Therefore, there is a case where the display of a self-shot video is inhibited by the display of a return video that is less necessary. If a return video is displayed on a self-shot video in a picture-in-picture (PinP) mode, for example, it may be impossible to view the area of the self-shot video over which the return video is displayed.

### SUMMARY OF THE INVENTION

The present invention provides an image pickup apparatus that can switch a method for displaying a return video in accordance with the need to display the return video, thereby reducing the inhibition caused by displaying a return video when displaying a self-shot video, a control method therefor and a storage medium.

Accordingly, the present invention provides an image pickup apparatus connected to an external apparatus, comprising at least one memory and at least one processor which function as a first receiving unit configured to receive a tally signal, a second receiving unit configured to receive a return video, and a control unit configured to switch a method for displaying the return video, wherein the control unit switches the method for displaying the return video, depending on a state of the tally signal in the first receiving unit.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of a digital video camera, which is an image pickup apparatus according to an embodiment of the present invention.

FIG. 2 is a view showing an example of switching a method for displaying a return video in a case of a setting in which the return video is displayed in a PinP mode with respect to a self-shot video.

FIG. 3 is a diagram showing an example of switching a method for displaying a return video in a case of a setting in which the return video is displayed in a mixing mode with respect to a self-shot video.

FIG. 4 is a diagram showing an example of switching a method for displaying a return video in a case of a setting in which the return video and a self-shot video are displayed in a screen separation mode.

FIG. 5 is a flowchart showing an example of a display switching control process for a return video.

### DESCRIPTION OF THE EMBODIMENTS

The present invention will now be described in detail below with reference to the accompanying drawings showing embodiments thereof.

Some embodiments of the present invention will be described below in detail with reference to the drawings. Each of the embodiments to be described below is merely an example of configurations that can implement the present invention. The following embodiments can be appropriately modified or varied in accordance with the configuration of an apparatus to which the present invention is to be applied and various conditions. Furthermore, not all conceivable combinations of elements included in the following embodiments are essential to implement the present invention, and some of the elements can be appropriately omitted. Therefore, the scope of the present invention is not limited by the configurations described in the following embodiments. In addition, a plurality of the configurations described in the embodiments can be combined together unless they contradict with each other.

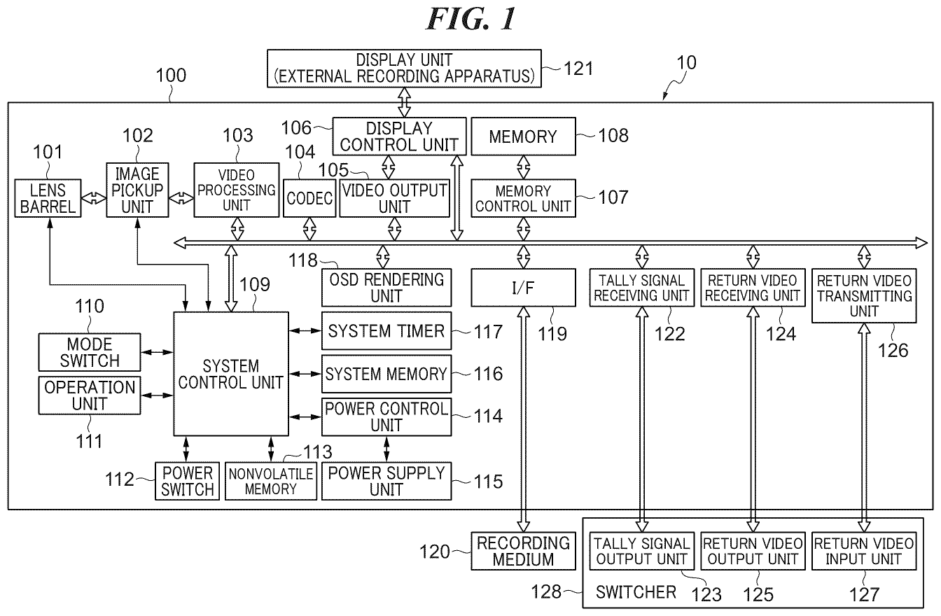

FIG. 1 is a block diagram showing a hardware configuration of a digital video camera 10, which is an image pickup apparatus according to an embodiment of the present invention.

As shown in FIG. 1, the digital video camera 10 is communicably connected to a recording medium 120, a display unit 121, and a switcher 128 that are all disposed outside.

As shown in FIG. 1, the digital video camera 10 includes a housing 100 that contains a plurality of elements. The elements contained in the digital video camera 10 include a video processing unit 103, a codec 104, a video output unit 105, a memory control unit 107, an OSD rendering unit 118, an I/F 119, and a system control unit 109. The elements contained in the digital video camera 10 also include a tally signal receiving unit 122, a return video receiving unit 124, and a return video transmitting unit 126. Those elements are interconnected via a bus.

The elements contained in the digital video camera 10 further include a lens barrel 101, an image pickup unit 102, a mode switch 110, and an operation unit 111. The elements contained in the digital video camera 10 also include a power switch 112, a nonvolatile memory 113, a power control unit 114, a power supply unit 115, a system memory 116, and a system timer 117.

The system control unit 109 is connected to the lens barrel 101, the image pickup unit 102, the mode switch 110, the operation unit 111, the power switch 112, the nonvolatile memory 113, the power control unit 114, the system memory 116, and the system timer 117.

The lens barrel 101 has image pickup lenses, including a focus lens and a stabilizing lens, and a diaphragm mechanism. The lens barrel 101 may be integrated with the housing 100 or may be detachable from the housing 100.

The image pickup unit 102 includes: an image pickup sensor that converts an optical image collected and formed by the image pickup lenses disposed inside the lens barrel 101 into an analog electrical signal; and an A/D converter that converts the analog electrical signal into a digital signal (video data).

The video processing unit 103 subjects the video data from the image pickup unit 102 or the memory control unit 107 to predetermined image processes, such as a resizing process, a trimming process, a color converting process, and a barrel distortion correcting process and then generates a VRAM in a memory 108 via the memory control unit 107. In addition, the video processing unit 103 subjects the video data to a predetermined arithmetic process and supplies the arithmetic result to the system control unit 109. This calculation result is used for various control processes, such as exposure control, ranging control, and stabilizing control. Based on the result of subject detection which has been calculated by the video processing unit 103, for example, the video processing unit 103 performs an autofocus (AF) process, an automatic exposure (AE) process, and a stabilizing process. In addition, based on the arithmetic result on the video data, the video processing unit 103 can perform an automatic white balance (AWB) process.

The codec 104 encodes the VRAM generated by the video processing unit 103 in conformity with a predetermined moving image compression scheme (such as MPEG-2 or H.264). In addition, the codec 104 decodes encoded video data supplied from the memory control unit 107 to generate a new VRAM. This new VRAM is subjected to a predetermined image process by the video processing unit 103 and then supplied to the memory control unit 107.

The video output unit 105 superimposes a plurality of VRAMs that has been read from the memory 108 via the memory control unit 107, thereby generating a video signal. In this case, the video output unit 105 can add metadata specified by the system control unit 109 to this video signal. It should be noted that the video output unit 105 can independently generate individual video signals for a plurality of display parts 121 and output the video signals via a display control unit 106.

The display unit 121 is a display apparatus connected to digital video camera 10 and displays an input video signal. Alternatively, the display unit 121 may be provided in the digital video camera 10. The display unit 121 can have a plurality of display apparatuses. The display unit 121 may be formed of a display member, such as a liquid crystal panel or an organic EL panel. Alternatively, the display unit 121 may be an external recording apparatus for recording a video signal, which is disposed outside the digital video camera 10.

The display control unit 106 establishes the connection to the display unit 121 and outputs the video signal that has been output from the video output unit 105, to the display unit 121. In short, a self-shot video being shot by the digital video camera 10 (or a live video being picked up by the image pickup unit 102 and being subjected to the image process by video processing unit 103) is output from the video output unit 105 and displayed on the display unit 121. The digital video camera 10 and the display unit 121 are connectable together in conformity with the serial digital interface (SDI) standard, for example. It should be noted that the digital video camera 10 and the display unit 121 may be connected in a wired or wireless manner with another technique. For example, the digital video camera 10 and the display unit 121 may be connected together by an HDMI (registered trademark) cable, so that a video signal and signal specification information may be transmitted from one of the digital video camera 10 and the display unit 121 to the other. In addition, the digital video camera 10 and the display unit 121 may be connected via a wireless LAN.

The memory control unit 107 mediates an access request from each individual unit to the memory 108.

The memory 108 stores VRAMs to be handled by the video processing unit 103, the codec 104, the video output unit 105, and the OSD rendering unit 118. In addition, the memory 108 can temporarily store the encoded video data that has been output from the codec 104 and encoded video data that has been read from the recording medium 120. The memory 108 has an enough recording capacity to store a moving image and sound for a predetermined time.

The system control unit 109 is a control unit that integrally controls the whole of the digital video camera 10 and is formed of an arithmetic processor, such as a central processing unit (CPU). Alternatively, the system control unit 109 may include a plurality of CPU cores. The CPU cores can independently process tasks described in a program, which will be described later.

The nonvolatile memory 113 is an electrically recordable and erasable recording medium. The nonvolatile memory 113 records control information, such as programs and parameters, to be used by the system control unit 109. These programs include a program for performing a process shown in a flowchart, which will be described later.

The system memory 116 is a volatile recording medium and is formed of a random access memory (RAM), for example. It should be noted that the system memory 116 may be used commonly with the memory 108. In this case, the access to the memory 108 serving as the system memory 116 is mediated by the memory control unit 107. Thus, a small-capacity, fast-accessible memory (such as a cache memory) may be provided and directly connected to the system control unit 109.

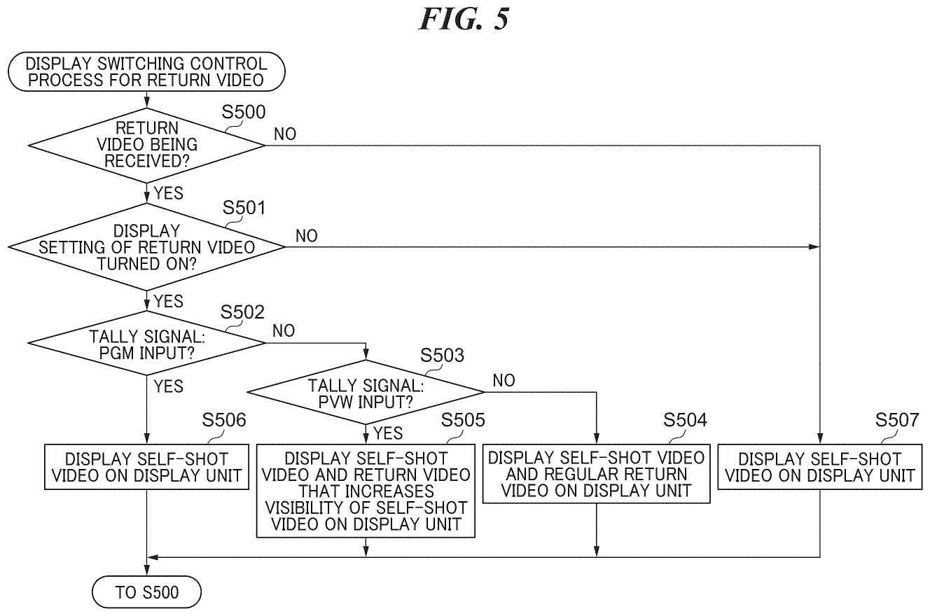

The system control unit 109 (control unit) deploys, in the system memory 116, programs and operational variables and constants stored in the nonvolatile memory 113 and executes the programs, thereby controlling each individual unit in the digital video camera 10. As a result, the system control unit 109 realizes individual operations of the present embodiment, such as a display switching control process for a return video, which will be described later with reference to FIG. 5. The system control unit 109 can control display operations to be performed by the memory 108, the OSD rendering unit 118, and the video output unit 105.

The mode switch 110 is a switch used to select in which mode the digital video camera 10 is to operate. The operation mode (such as a camera mode or a reproduction mode) designated by the position of the switch is reported to the system control unit 109.

The operation unit 111 is an operation unit used to enter various instructions in the system control unit 109. The operation unit 111 includes, for example, the following elements:
a menu button through which a menu screen for performing various settings is to be displayed on the display unit 121;
a cancel button;
arrow keys (up arrow key, down arrow key, left arrow key, and right arrow key);
A SET button;
a function switching button (AF/MF switching button);
a REC button through which the recording of a moving image is to be started or stopped; and
an assignment button through which any function can be assigned to the menu setting;

Using the menu screen displayed on the display unit 121, the arrow keys, and the SET button, a user can intuitively give various setting instructions. It should be noted that the user may operate the REC button to give the recording start/stop instruction for recording a video signal on the display unit 121 (external recording apparatus).

The power switch 112 is a push button used to switch between a power-on state and a power-off state.

The power control unit 114 includes a battery detection circuit, a DC-DC converter, and a switching circuit that switches between blocks to be energized and detects whether a battery is attached, which type of the battery is attached, and how much the battery level remains. The power control unit 114 controls the DC-DC converter based on the above detection result and an instruction from the system control unit 109 and applies a voltage required for the operation to each unit (e.g., the recording medium 120) over a necessary period.

The power supply unit 115 is formed of at least one of a primary battery (alkaline battery, lithium battery, etc.), a secondary battery (NiCd battery, NiMH battery, Li battery, etc.), and an AC adapter.

The system timer 117 is a timing generating unit used for various types of control and is also a clocking unit that reads a time indicated by a built-in clock (not shown). The system control unit 109 controls the operation of each unit based on a timing generated by the system timer 117.

The OSD rendering unit 118 provides an on-screen display (OSD) function by which multiple pieces of setting information are superimposed on video data. More specifically, the OSD rendering unit 118 renders character strings and icons representing the state and settings of the digital video camera 10 as well as various display frames and markers (i.e., the OSD) to the VRAMs stored in the memory 108. Display information, such as the character strings and the icons, used for the above on-screen display function is stored in the nonvolatile memory 113 and, as necessary, is read by the OSD rendering unit 118.

The I/F 119 is a connection interface that enables the recording medium 120 (external recording apparatus) to be connected to the digital video camera 10.

The recording medium 120 is a recording medium on which encoded video data and data associated with the video data are to be stored as image files. The encoded video data stored on the memory 108 is supplied to the recording medium 120 via the I/F 119 and is recorded thereon. The encoded video data and the associated data that have been stored on the recording medium 120 are read at the I/F 119 and transferred to the memory 108. The recording medium 120 may be a medium (memory card, HDD, other discs, etc.) to be detachably attached to the digital video camera 10 or a medium (flash memory, HDD, etc.) disposed inside the digital video camera 10.

The switcher 128 (external apparatus) is a device connected to the digital video camera 10 and includes: a tally signal output unit 123 that transmits a tally signal; a return video output unit 125 that transmits a return video; and a return video input unit 127 that receives the return video.

The tally signal receiving unit 122 (first receiving unit) receives the tally signal from the tally signal output unit 123 in the switcher 128 disposed outside. The reception of the tally signal in this case is reported to the system control unit 109. In response to this, the system control unit 109 causes the OSD rendering unit 118 to perform drawing in accordance with the content of the received tally signal. As a result, the OSD rendering unit 118 draws, for example, an icon that indicates the reception of the tally signal and/or a frame (image frame) for changing the color of the periphery of the image displayed on the display unit 121.

The return video receiving unit 124 (second receiving unit) receives the return video from the return video output unit 125 in the switcher 128 disposed outside. The video data received in this case is stored on the memory 108, processed by the video output unit 105 under the control of the system control unit 109, and displayed on the display unit 121.

The return video transmitting unit 126 transmits the return video to the return video input unit 127 in the switcher 128 disposed outside.

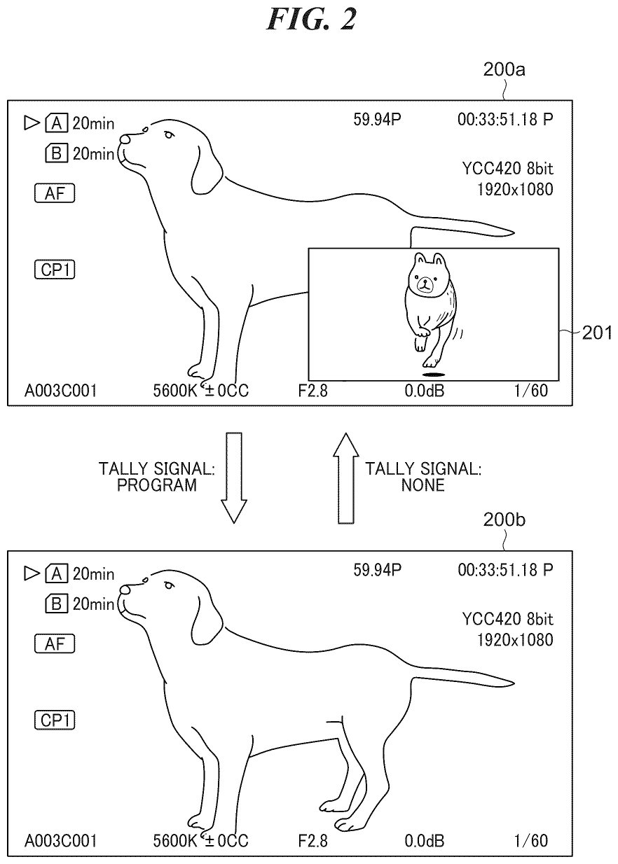

FIG. 2 is a view showing an example of switching a method for displaying the return video in a case of a setting (first setting) in which the return video is displayed in a picture-in-picture (PinP) mode with respect to a self-shot video.

Hereinafter, the state “tally signal: none” (second state) refers to a state where the tally signal receiving unit 122 is not receiving the tally signal. The state “tally signal: PROGRAM” (first state) refers to a state where the tally signal receiving unit 122 is receiving a tally signal of PROGRAM. Herein, the tally signal of PROGRAM refers to a tally signal indicating that the operator of the switcher 128 selects the video being shot by the digital video camera 10 as the video (return video) to be currently broadcasted. The state “tally signal PREVIEW” (third state) refers to a state where the tally signal receiving unit 122 is receiving a tally signal of PREVIEW. Herein, the tally signal of PREVIEW refers to a tally signal indicating that the operator of the switcher 128 selects the video being shot by the digital video camera 10 as the video that will be broadcasted/distributed next.

A screen 200a in FIG. 2 corresponds to a screen displayed on the display unit 121 when the tally signal receiving unit 122 is in the state “tally signal: none”, where a return video 201 is displayed in the PinP mode simultaneously with a self-shot video.

A screen 200b in FIG. 2 corresponds to a screen displayed on the display unit 121 when the tally signal receiving unit 122 is switched to the state “tally signal: PROGRAM” during the displaying of the screen 200a. In this case, the return video 201 that has been displayed in the PinP mode on the self-shot video is switched to the non-displayed state. Although not shown in FIG. 2, when the tally signal receiving unit 122 is in the state “tally signal: PROGRAM”, a red frame is optionally displayed around the screen 200b.

When the tally signal receiving unit 122 is returned from the state “tally signal: PROGRAM” to the state “tally signal: none”, the screen 200b is switched back to the screen 200a on which the return video 201 is displayed in the PinP mode.

This functionality is employed in consideration of the following fact: when the tally signal receiving unit 122 is in the state “tally signal: PROGRAM”, the return video is a video based on the self-shot video, in which case it is generally less necessary to display the return video on the display unit 121.

Although not shown in FIG. 2, when the tally signal receiving unit 122 is switched to the state “tally signal: PREVIEW”, the screen 200b is switched to a screen 200c on which the return video 201 is displayed so that the visibility of the self-shot video becomes higher than that on the screen 200b. Examples of a method for increasing the visibility of the self-shot video include: a method for downsizing the display (PinP display) of the return video 201; and a method for increasing the transmittance of the return video displayed in the PinP mode. Although not shown in FIG. 2, when the tally signal receiving unit 122 is in the state “tally signal: PREVIEW”, a green frame may be displayed around the screen 200c.

The reduction proportion and transmittance of the return video displayed in the PinP mode may be set at the initial setup of the digital video camera 10, depending on the state of the tally signal receiving unit 122. Alternatively, the reduction proportion and transmittance thereof may be set changeable through a user's operation on the operation unit 111.

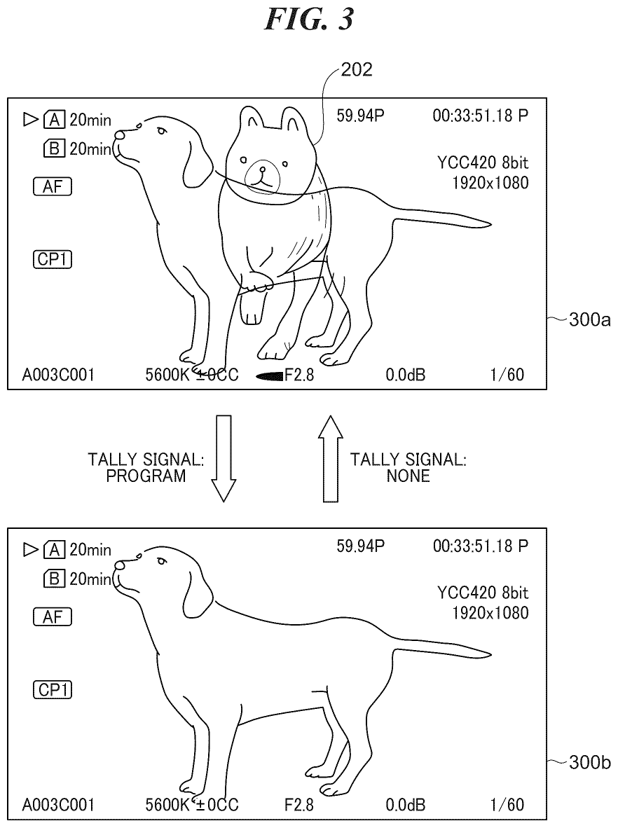

FIG. 3 is a view showing an example of switching a method for displaying the return video in a case of a setting (second setting) in which the return video is displayed in a mixing (translucent superimposing) mode with respect to a self-shot video.

A screen 300a in FIG. 3 corresponds to a screen displayed on the display unit 121 when the tally signal receiving unit 122 is in the state “tally signal: none”, where a return video 202 is displayed in the mixing mode simultaneously with a self-shot video.

A screen 300b in FIG. 3 corresponds to a screen displayed on the display unit 121 when the tally signal receiving unit 122 is switched to the state “tally signal: PROGRAM” during the displaying of the screen 300a. In this state, the return video 202 that has been displayed on the self-shot video in the mixing mode is switched to the non-displayed state.

When the tally signal receiving unit 122 is returned from the state “tally signal: PROGRAM” to the state “tally signal: none”, the screen 300b is switched back to the screen 300a on which the return video 202 is displayed in the mixing mode.

This functionality is employed in consideration of the following fact: when the tally signal receiving unit 122 is in the state “tally signal: PROGRAM”, the return video is a video based on the self-shot video, in which case it is generally less necessary to display the return video on the display unit 121.

Although not shown in FIG. 3, when the tally signal receiving unit 122 is switched to the state “tally signal: PREVIEW”, the screen 300b is switched to a screen 300c on which the return video 202 is displayed so that the visibility of the self-shot video becomes higher than that on the screen 300b. Examples of a method for increasing the visibility of the self-shot video include a method for increasing the transmittance of the return video 202 displayed in the mixing mode.

The transmittance of the return video displayed in the mixing mode may be set at the initial setup of the digital video camera 10, depending on the state of the tally signal receiving unit 122. Alternatively, the transmittance thereof may be set changeable through a user's operation on the operation unit 111.

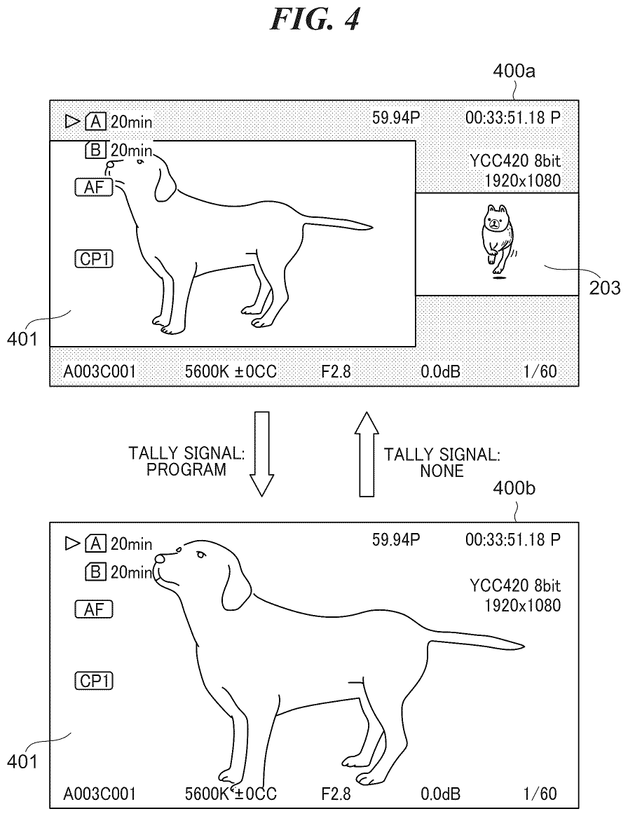

FIG. 4 is a diagram showing an example of switching a method for displaying the return video in a case of a setting (third setting) in which the return video and the self-shot video are displayed in a screen separation mode.

A screen 400a in FIG. 4 corresponds to a screen displayed on the display unit 121 when the tally signal receiving unit 122 is in the state “tally signal: none”, where, a return video 203 and a self-shot video 401 are displayed in the screen separation mode.

A screen 400b in FIG. 4 corresponds to a screen displayed on the display unit 121 when the tally signal receiving unit 122 is switched to the state “tally signal: PROGRAM” during the displaying of the screen 400a. In this state, the return video 203 which has been displayed in the screen separation mode is switched to the non-displayed state, whereas the self-shot video 401 which has been displayed in the screen separation mode is displayed in the full-screen mode.

When the tally signal receiving unit 122 is returned from the state “tally signal: PROGRAM” to the state “tally signal: none”, the screen 400b is switched back to the screen 400a on which the return video 203 is displayed in the screen separation mode.

This functionality is employed in consideration of the following fact: when the tally signal receiving unit 122 is in the state “tally signal: PROGRAM”, the return video is a video based on the self-shot video, in which case it is generally less necessary to display the return video on the display unit 121.

Although not shown the screen in FIG. 4, when the tally signal receiving unit 122 is switched to the state “tally signal: PREVIEW”, the screen 400b is switched to a screen 400c on which the return video 203 is displayed so that the visibility of the self-shot video becomes higher than that on the screen 400b.

Examples of a method for increasing the visibility of the self-shot video include: a method for displaying, in the screen separation mode, the return video 203 with a decreased size and the self-shot video with an increased size.

The display sizes of the return video 201 and the self-shot video may be set at the initial setup of the digital video camera 10, depending on the state of the tally signal receiving unit 122. Alternatively, the display sizes thereof may be set changeable through a user's operation on the operation unit 111.

It should be noted that any of the methods shown in FIGS. 2 to 4 may be utilized as long as a self-shot video and a return video are displayed simultaneously on the display unit 121. Alternatively, any other method that does not limit the present invention may be utilized. Furthermore, one of the methods for simultaneously displaying a self-shot video and a return video on the display unit 121 may be set in an initial setting stage of the digital video camera 10, or the methods may be set changeable in response to a user's operation on the operation unit 111.

FIG. 5 is a flowchart showing an example of a display switching control process for a return video.

In step S500, the system control unit 109 determines whether the return video receiving unit 124 is receiving the return video. When the return video receiving unit 124 is receiving the return video (YES in step S500), the process proceeds to step S501. When the return video receiving unit 124 is not receiving the return video (NO in step S500), the process proceeds to step S507. In step S501, the system control unit 109 determines whether the display unit 121 is set to display the return video. When the display unit 121 is set to display the return video (YES in step S501), the process proceeds to step S502. When the display unit 121 is not set to display the return video (NO in step S501), the process proceeds to step S507.

In step S502, the system control unit 109 determines whether the tally signal receiving unit 122 is receiving the tally signal of PROGRAM (whether the tally signal receiving unit 122 is in the state “tally signal: PROGRAM”). When the tally signal receiving unit 122 is receiving the tally signal of PROGRAM (YES in step S502), the process proceeds to step S506. When the tally signal receiving unit 122 is not receiving the tally signal of PROGRAM (NO in step S502), the process proceeds to step S503.

In step S503, the system control unit 109 determines whether the tally signal receiving unit 122 is receiving the tally signal of PREVIEW (whether the tally signal receiving unit 122 is in the state “tally signal: PREVIEW”). When the tally signal receiving unit 122 is receiving the tally signal of PREVIEW (YES in step S503), the process proceeds to step S505. When the tally signal receiving unit 122 is not receiving the tally signal of PREVIEW (NO in step S503), the process proceeds to step S504.

In step S504, the system control unit 109 determines that the tally signal receiving unit 122 is in the state “tally signal: none” and controls the display unit 121 in such a way that the display unit 121 simultaneously displays both of the self-shot video and the return video. The process then returns to step S500.

In step S505, the system control unit 109 determines that the tally signal receiving unit 122 is in the state “tally signal: PREVIEW” and controls the display unit in such a way that the display unit displays both of the self-shot video and the return video. In this case, the system control unit 109 controls the display unit in such a way that the display unit displays the return video with the visibility of the self-shot video being higher than that in step S504. The process then returns to step S500.

In step S506, the system control unit 109 determines that the tally signal receiving unit 122 is in the state “tally signal: PROGRAM” and controls the display unit 121 in such a way that the display unit 121 does not display the return video but displays the self-shot video. The process then returns to step S500.

In step S507, the system control unit 109 controls the display unit 121 in such a way that the display unit 121 displays the self-shot video. The process then returns to step S500.

With the process shown in FIG. 5, as described above, the system control unit 109 switches a method for displaying a return video in accordance with the need to display the return video which depends on the state of the tally signal receiving unit 122. Consequently, it is possible to produce an effect of reducing the risk of the display of the return video inhibiting the display of the self-shot video on the display unit 121.

It should be noted that, in the present embodiment, the displayed size, displayed/non-displayed state, and transmittance of the return video are changed depending on the state of the tally signal receiving unit 122; however, the present invention is not limited to this scheme. If it is possible to produce the same effect as the above, for example, the method for displaying the self-shot video may be switched depending on the state of the tally signal receiving unit 122.

The present embodiment has been described regarding the case where the output destination to which the information about the method for displaying the return video is to be output is the display unit 121; however, the output destination may be at least one of a plurality of display parts and an external recording apparatus. Moreover, the method for switching the display of the return video depending on the state of the tally signal receiving unit 122 may be set changeable through a user's operation on the operation unit 111 for each output destination.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-031326, filed Mar. 1, 2024 which is hereby incorporated by reference herein in its entirety.

What is claimed is:

1. An image pickup apparatus connected to an external apparatus, comprising:
at least one memory and at least one processor which function as:
a first receiving unit configured to receive a tally signal;
a second receiving unit configured to receive a return video; and
a control unit configured to switch a method for displaying the return video,
wherein the control unit switches the method for displaying the return video, depending on a state of the tally signal in the first receiving unit.

2. The image pickup apparatus according to claim 1, wherein
in a case where, even when the return video is set to be displayed simultaneously with a self-shot video being shot by the image pickup apparatus, the first receiving unit enters a first state where a tally signal of PROGRAM is being received as the tally signal, the control unit switches the method for displaying the return video to a method for displaying only the self-shot video by setting the return video to a non-displayed state.

3. The image pickup apparatus according to claim 2, wherein
in a case where the return video is set to be displayed simultaneously with the self-shot video, and the first receiving unit enters a second state where the tally signal is not being received, the control unit switches the method for displaying the return video to a method for displaying the return video simultaneously with the self-shot video.

4. The image pickup apparatus according to claim 3, wherein
in a case where the return video is set to be displayed simultaneously with the self-shot video, and the first receiving unit enters a third state where a tally signal of PREVIEW is being received as the tally signal, the control unit switches the method for displaying the return video in such a way that the return video is displayed simultaneously with the self-shot video, with visibility of the self-shot video being higher than the visibility of the self-shot video in the first state.

5. The image pickup apparatus according to claim 2, wherein
in a case where, even when the return video is set to be displayed in a PinP mode with respect to the self-shot video, the first receiving unit enters the first state, the control unit switches the method for displaying the return video to a method for displaying only the self-shot video by setting the return video to a non-displayed state.

6. The image pickup apparatus according to claim 3, wherein
in a case where the return video is set to be displayed in a PinP mode with respect to the self-shot video, and the first receiving unit enters the second state, the control unit switches the method for displaying the return video to a method for displaying the return video in the PinP mode.

7. The image pickup apparatus according to claim 4, wherein
in a case where the return video is set to be displayed in a PinP mode with respect to the self-shot video, and the first receiving unit enters the third state, the control unit switches the method for displaying the return video to a method for displaying the return video in the PinP mode with a displayed size of the return video decreased.

8. The image pickup apparatus according to claim 4, wherein
in a case where the return video is set to be displayed in a PinP mode with respect to the self-shot video, and the first receiving unit enters the third state, the control unit switches the method for displaying the return video to a method for displaying the return video in the PinP mode with transmittance of the return video increased.

9. The image pickup apparatus according to claim 2, wherein
in a case where, even when the return video is set to be displayed in a mixing mode with respect to the self-shot video, the first receiving unit enters the first state, the control unit switches the method for displaying the return video to a method for displaying only the self-shot video by setting the return video to a non-displayed state.

10. The image pickup apparatus according to claim 3, wherein
in a case where the return video is set to be displayed in a mixing mode with respect to the self-shot video, and the first receiving unit enters the second state, the control unit switches the method for displaying the return video to a method for displaying the return video in the mixing mode.

11. The image pickup apparatus according to claim 4, wherein
in a case where the return video is set to be displayed in a mixing mode with respect to the self-shot video, and the first receiving unit enters the third state, the control unit switches the method for displaying the return video to a method for displaying the return video in the mixing mode with transmittance of the return video increased.

12. The image pickup apparatus according to claim 2, wherein
in a case where, even when the return video is set to be displayed in a screen separation mode with respect to the self-shot video, the first receiving unit enters the first state, the control unit switches the method for displaying the return video to a method for displaying only the self-shot video by setting the return video to a non-displayed state.

13. The image pickup apparatus according to claim 3, wherein
in a case where the return video is set to be displayed in a screen separation mode with respect to the self-shot video, and the first receiving unit enters the second state, the control unit switches the method for displaying the return video to a method for displaying the return video in the screen separation mode.

14. The image pickup apparatus according to claim 4, wherein
in a case where the return video is set to be displayed in a screen separation mode with respect to the self-shot video, and the first receiving unit enters the third state, the control unit switches the method for displaying the return video to a method for displaying the return video in the screen separation mode with a displayed size of the return video decreased but a displayed size of the self-shot video increased.

15. The image pickup apparatus according to claim 2, wherein the setting in which the return video is displayed simultaneously with the self-shot video is set changeable, in response to a user's operation, to one of a first setting in which the return video is displayed in a PinP mode with respect to the self-shot video, a second setting in which the return video is displayed in a mixing mode with respect to the self-shot video, and a third setting in which the return video is displayed in a screen separation mode with respect to the self-shot video.

16. The image pickup apparatus according to claim 7, wherein the displayed size of the return video in the PinP mode in each of the second state and the third state is set changeable through a user's operation.

17. The image pickup apparatus according to claim 8, wherein the transmittance of the return video displayed in the PinP mode in each of the second state and the third state is set changeable in response to a user's operation.

18. The image pickup apparatus according to claim 11, wherein the transmittance of the return video displayed in the mixing mode in each of the second state and the third state is set changeable in response to a user's operation.

19. The image pickup apparatus according to claim 14, wherein the displayed sizes of the return video and the self-shot video in each of the second state and the third state is set changeable through a user's operation.

20. The image pickup apparatus according to claim 1, wherein the method for displaying the return video depending on the state of the first receiving unit is set changeable for each output destination to which the control unit outputs the information about the method for displaying the return video.

21. The image pickup apparatus according to claim 20, wherein the output destination is at least one of a display unit and an external recording apparatus.

22. A control method for an image pickup apparatus connected to an external apparatus,
wherein the method comprises:
a first receiving step of receiving a tally signal;
a second receiving step of receiving a return video; and
a control step of switching a method for displaying the return video with respect to a self-shot video,
wherein in the control step, the method for displaying the return video is switched depending on a state of the tally signal in the first receiving step.

23. A non-transitory computer readable storage medium storing a program that causes a computer to execute a control method for an image pickup apparatus connected to an external apparatus,
wherein the method comprises:
a first receiving step of receiving a tally signal;
a second receiving step of receiving a return video; and
a control step of switching a method for displaying the return video with respect to a self-shot video,
wherein in the control step, the method for displaying the return video is switched depending on a state of the tally signal in the first receiving step.
